(19) United States
(12) Patent Application Publication
(10) Pub. No.: US 2015/0042668 A1
(43) Pub. Date: Feb. 12, 2015

(54) TERMINAL AND CONTROL METHOD THEREOF

(71) Applicant: SAMSUNG DISPLAY CO., LTD., Yongin-City (KR)

(72) Inventor: Jin Young JEON, Cheonan-si, Chungcheongnam-do (KR)

(21) Appl. No.: 14/335,109

(22) Filed: Jul. 18, 2014

(30) Foreign Application Priority Data
Aug. 8, 2013 (KR) 10-2013-0094417

(51) Int. Cl. G09G 5/393

(52) U.S. Cl. CPC G09G 5/393
USPC 345/534

(57) ABSTRACT

A terminal includes a controller, a driver, and a display. The controller transmits image data based on a first signal. The driver includes an internal memory and performs a memory write operation for the transmitted image data in the internal memory. The display output the image data, for which the memory write operation in the internal memory has been performed, based on a memory scan operation. The performs the memory scan operation at a first frequency and generates a second signal based on when the memory scan operation and memory write operation for the internal memory are to alternate. The controller transmits the image data based on the second signal.

### CROSS-REFERENCE TO RELATED APPLICATION

Korean Patent Application No. 10-2013-0094417, filed on Aug. 8, 2013, and entitled: “Terminal and Control Method Thereof,” is incorporated by reference herein in its entirety.

### BACKGROUND

1. Field

One or more embodiments described herein relate to a processing terminal.

2. Description of the Related Art

Processing terminals can be mobile/portable or stationary. Mobile terminals include handheld and vehicle mounted terminals. One example of a handheld terminal is a multimedia player. Multimedia players have complex functions which include, for example, camera functions, music reproduction, games, and broadcast display. These and other functions are driven by various forms of hardware and/or software.

The frequencies used for writing image data may be different from frequencies for performing memory scans. The difference in these frequencies may cause a tearing effect, which produces a screen having a torn appearance. For example, a tearing effect may occur when a memory write is executed later than a memory scan, or when a memory write ends earlier than a memory scan for a frame of image data.

### SUMMARY

In accordance with one embodiment, a terminal includes a controller configured to transmit image data based on a first signal; a driver including an internal memory and configured to perform a memory write operation for the transmitted image data in the internal memory; and a display configured to receive and output the image data for which the memory write operation in the internal memory has been performed, when a memory scan for the internal memory is performed, wherein: the driver is configured to perform a memory scan operation at a first frequency for the internal memory, and to generate a second signal based on when the memory scan operation and memory write operation for the internal memory are to alternate, and the controller is to transmit the image data based on the second signal. The driver may include a signal controller configured to output the first and second signals.

When the driver performs a memory scan operation for the internal memory at a second frequency different from the first frequency, the driver may be configured to output the second signal based on a size of the second frequency.

When the second frequency is greater than the first frequency, an output time of the second signal may be delayed relative to an output time of the first signal. When the second frequency is less than the first frequency, the output time of the second signal may be advanced relative to the output time of the first signal. The first and second signals may be TE signals.

When the driver receives the image data based on the second signal, the driver may perform the memory write operation again for the internal memory. The second frequency may be 120 Hz and the first frequency may be 60 Hz. The second frequency may be 30 Hz and the first frequency may be 60 Hz.

In accordance with another embodiment, a method for controlling a terminal includes receiving image data transmitted based on a first signal; performing a memory write operation for the transmitted image data in an internal memory; performing a memory scan operation for the internal memory at a first frequency; determining, in advance, when the memory scan operation and memory write operation for the internal memory are to alternate; outputting a second signal based on when the memory scan operation and memory write operation are to alternate; and receiving the transmitted image data based on the second signal. The method may further include outputting the first and second signals from a driver of a display.

The determining operation may include performing a memory scan for the internal memory at a second frequency different from the first frequency; and outputting the second signal based on a size of the second frequency.

When the second frequency is greater than the first frequency, the second signal may have an output time delayed relative to an output time of the first signal. When the second frequency is less than the first frequency, the second signal may have an output time advanced relative to the output time of the first signal. The first and second signals may be TE signals.

When the driver receives image data based on the second signal, the memory write operation for the internal memory may be performed again. The second frequency may be 120 Hz and the first frequency may be 60 Hz. The second frequency may be 30 Hz and the first frequency may be 60 Hz.

In accordance with another embodiment, an apparatus includes an interface; and a controller to control writing of image data to a memory and to control scanning of the memory, wherein the controller is to shift a timing of a control signal to change a frequency of a memory scan operation, the changed frequency to cause the memory scan operation to be performed for addresses of the memory for which a memory write operation has been performed, and wherein the controller is to output the control signal through the interface. The controller may shift the timing of the control signal based on when the memory scan operation and memory write operation are to alternate.

### BRIEF DESCRIPTION OF THE DRAWINGS

Features will become apparent to those of skill in the art by describing in detail exemplary embodiments with reference to the attached drawings in which:

FIG. 1 illustrates an embodiment of a terminal;

FIG. 2 illustrates an embodiment of a method for controlling a terminal;

FIG. 3 illustrates memory scan and memory write operations performed when the output time of a TE signal is delayed according to one embodiment;

FIG. 4 illustrates memory scan and memory write operations when the output time of a TE signal is advanced according to one embodiment;

FIG. 5 illustrates an embodiment of waveforms for controlling the terminal;

FIG. 6 illustrates memory scan and memory write operations according to a first comparative example;

FIG. 7 illustrates memory scan and memory write operations according to a second comparative example; and

FIG. 8 illustrates waveforms according to a comparative example.

### DETAILED DESCRIPTION

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

In accordance with one or more embodiments described herein, a mobile terminal may include a mobile phone, a smart phone, a laptop computer, a terminal for digital broadcasting, personal digital assistants (PDA), a portable multimedia player (PMP), and a navigation device. However, except for a case where the configuration according to the exemplary embodiment described in the specification can be applied only to the mobile terminal, it may be easily understood by those skilled in the art that the configuration can be applied to the stationary terminals such as a digital TV and a desktop computer.

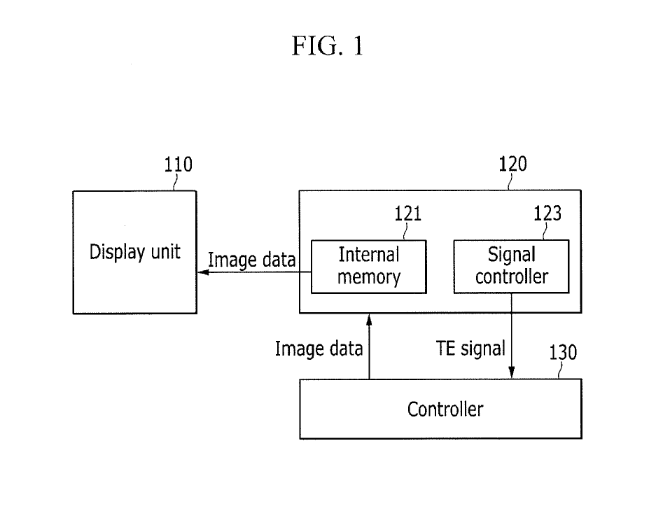

FIG. 1 illustrates an embodiment of a terminal which includes a display unit 110, a driver 120, and a controller 130. The display unit 110 displays (outputs) information processed by the terminal. For example, when the mobile terminal is in a call mode, the mobile terminal displays a user interface (UI) or a graphic user interface (GUI) related to a call. When the mobile terminal is in a video call mode or a photographing mode, the mobile terminal displays a photographed or/and received image, a UI, or a GUI.

The display unit 110 may include at least one of a liquid crystal display (LCD), a thin film transistor-liquid crystal display (TFT LCD), an organic light emitting diode (OLED), a flexible display, or a 3D display. When the display unit 110 and a sensor (e.g., touch sensor) for detecting a touch action have a mutual layer structure (e.g., a touch screen), display unit 110 may be used as an input device as well as an output device. The touch sensor may be or include, for example, a touch film, a touch sheet, or a touch pad.

The touch sensor may convert a change in pressure applied to a particular part of display unit 110, or a capacitance generated in a particular part of display unit 110, to an electrical input signal. The touch sensor may also be configured to detect pressure when a touch is made, e.g., a touch pressure as well as a touch position and area.

The display unit 110 receives data from the driver 120 and outputs an image. The driver 120 includes an internal memory 121 and a signal controller 123. The driver 120 stores image data from controller 130 in the internal memory 121. The driver 120 transmits the image data stored in the internal memory 121 to the display unit 110. According to one embodiment, driver 120 may receive digital image data, convert the digital image data to analog image data, and transmit the analog image data to display unit 110. Also, in one embodiment, signal controller 123 and controller 130 may be considered to be one controller, e.g., as included on a same integrated circuit chip.

Also, the signals transmitted between the controller 130 and signal controller 123, and/or between driver 120 and controller 130, and/or between driver 120 or internal memory 121 and display unit 110, may pass through one or more interfaces. The interfaces may be, for example, internal ports or leads of an integrated circuit chip or a signal line or conductive trace.

The driver 120 performs a memory scan to transmit the stored image data to the display unit 110. The driver 120 may also performs a memory write when receiving the image data from the controller 130.

The signal controller 123 transmits a transmit enable (TE) signal to the controller 130. According to one embodiment, the controller 130 transmits image data based on the TE signal.

The signal controller 123 may receive input image signals R, G, and B and an input control signal for controlling one or more displays thereof from an external graphic controller. The input image signals R, G, and B contain luminance information of each pixel PX. Luminance may be measured based on a predetermined number of gray scale values, for example, 1024=210, 256=28, or 64=26 gray scale values. Examples of the input control signal include a vertical synchronization signal Vsync, a horizontal synchronization signal Hsync, and/or a data enable signal DE.

A plurality of 1 horizontal periods (also referred to as 1H, which may be the same as one period of the horizontal synchronization signal Hsync) are gathered to display an image of one frame. In one embodiment, one frame may refer to a period after the vertical synchronization signal Vsync is applied and before the next vertical synchronization signal Vsync is applied. Further, in one embodiment, driver 120 may perform a memory scan when the data enable signal DE is high.

The controller 130 controls general operations of the mobile terminal. For example, controller 130 may perform control and processing operations related to a voice call, data communication, and/or a video call. The controller 130 transmits image data to driver 120. In one embodiment, the controller 130 transmits image data to internal memory 121. Additionally, or alternatively, controller 130 may start transmitting image data at a rising edge in which the TE signal changes from a low level to a high level. In another embodiment, controller 130 may start transmitting the image data when the TE signal changes from the high level to the low level.

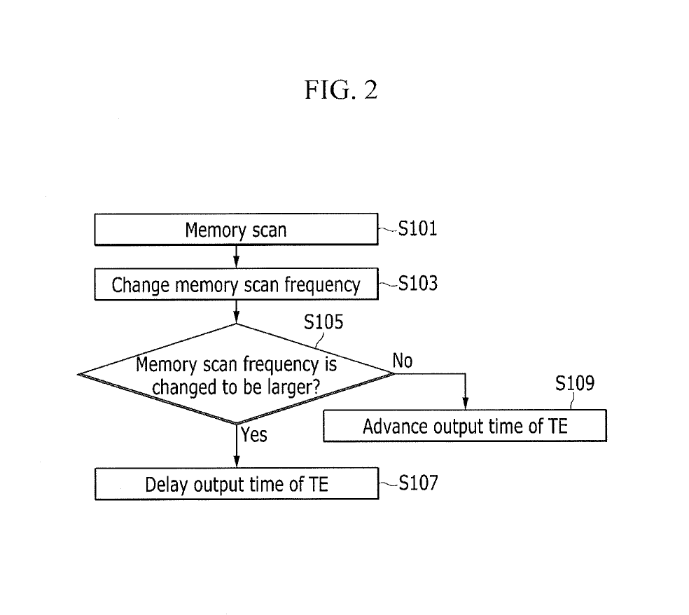

FIGS. 2 to 5 illustrate an embodiment of a method for controlling a terminal, which, for example, may be the terminal in FIG. 1 or a different terminal. The signal controller 123 transmits the TE signal to the controller 130. Thereafter, the signal controller 123 transmits the TE signal to the controller 130 based on a predetermined period. In one embodiment, the TE signal may be a pulse signal.

The controller 130 transmits first image data to the driver 120 based on the TE signal. The driver 120 performs a memory write for the received first image data in internal memory 121. The memory write may be performed once from a first access address to a last access address of the memory for one frame. Thereafter, driver 120 may perform a memory scan for the first image data for which the memory write has been performed, and may transmit the first image data to the display unit 110. The display unit 110 outputs the scanned image. The memory scan may be performed once from a first access address of the memory to a last access address for one frame.

When the driver 120 does not receive second image data from the controller 130, the driver 120 does not perform the memory write in the internal memory 121, but rather may perform the memory scan for internal memory 121 at every frame. The display unit 110 outputs the scanned image.

When the controller 130 transmits second image data different from the first image data, the controller 130 may transmit the second image data to the driver 120 based on the received TE signal. When driver 120 receives the second image data from controller 130, driver 120 performs a memory write operation in internal memory 121 again. Thereafter, driver 120 performs a memory scan operation for the second image data for which the memory write has been performed, and transmits the second image data to display unit 110. The memory write and memory scan may be performed at the same time, but this is not a necessity.

FIG. 2 illustrates operations included in the method for controlling the terminal. According to these operations, the driver 120 performs a memory scan for internal memory 121 at a first frequency at every frame in S101. At this time, a waveform of a signal TE1 may be opposite to (i.e., overlap) a waveform of data enable signal DE. That is, TE1 may be low when the data enable signal DE is high, and TE1 may be high when the data enable signal DE is low.

The driver 120 changes the memory scan frequency of the internal memory 121 from a first frequency to a second frequency in S103. The second frequency may be larger than the first frequency. The second frequency may be larger than the first frequency, for example, when driver 120 processes more data in comparison with the memory scan at the first frequency. For example, driver 120 may perform a memory scan at the first frequency when display unit 110 outputs a still image. Driver 120 may perform a memory scan at the second frequency when display unit 110 outputs a video.

In contrast, the second frequency may be smaller than the first frequency. The second frequency may be smaller than the first frequency when driver 120 processes less data in comparison with the memory scan at the first frequency. For example, driver 120 may performs a memory scan at the first frequency when the terminal normally operates, and driver 120 may performs a memory scan at the second frequency when terminal operates in a sleep or other reduced power mode.

The signal controller 123 determines whether the second frequency is larger than the first frequency in S105. When the second frequency is larger than the first frequency, the signal controller 123 delays an output time of the TE signal in S107. The signal TE corresponding to an output time which has been delayed is TE2.

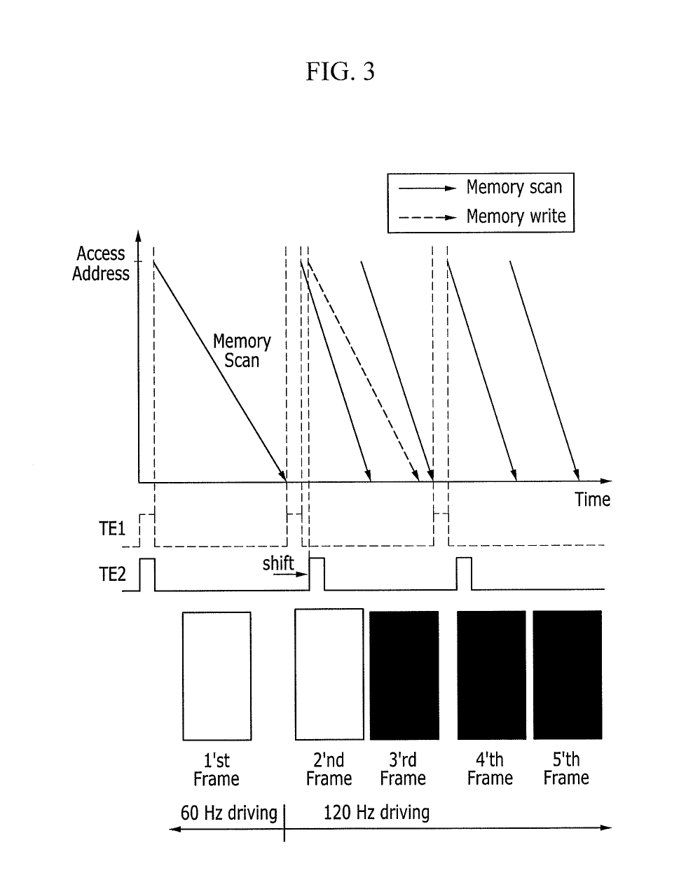

FIG. 3 illustrates a memory scan and a memory write in a case where the output time of the TE signal is delayed according to one embodiment. Referring to FIG. 3, driver 120 performs a memory scan at the first frequency in a first frame. At this time, signal controller 123 may transmit the TE1 signal to controller 130 In the first frame, display unit 110 outputs first image data according to the memory scan of driver 120. Although FIG. 3 illustrates that entire first image data is white, this may not be the case in other embodiments.

Thereafter, driver 120 changes the memory scan frequency to the second frequency. When driver 120 changes the memory scan frequency to the second frequency, signal controller 123 transmits the TE2 signal, having an output time delayed from the output time of TE1, to controller 130. In FIG. 3, the second frequency is larger than the first frequency. The controller 130 transmits second image data based on the TE2 signal. In this case, the TE2 signal is transmitted to controller 130 at a later timing compared with the existing TE1 signal. The driver 120 performs the memory write operation when the second image data is received. Accordingly, the memory write operation starts later than a memory scan operation of a second frame.

Further, because the memory scan frequency increases from the first frequency to the second frequency, the memory scan is performed from a first access address to a last access address of internal memory 121 at a faster speed compared with the first frequency. As a result, the memory write operation is performed only for the access address for which the memory scan has been performed. Accordingly, the first image data is output to display unit 110 in the second frame, and the second image data is output in a third frame.

That is, driver 120 may determine in advance when the memory scan for the internal memory 121 and the memory write for the internal memory 121 are to alternate, and may transmit the TE2 signal (having an output time delayed from the output time of TE1) to controller 130.

In FIG. 3, the first frequency is 60 Hz and the second frequency is 120 Hz. In other embodiments, the first and second frequencies may have different values. Further, although FIG. 3 illustrates that the entire second image data is black, the second image may include non-black data in other embodiments. Thereafter, because controller 130 does not transmit new image data, the second image data is also output in a fourth frame and a fifth frame.

When the second frequency is less than the first frequency, signal controller 123 advances the output time of the TE signal in S109.

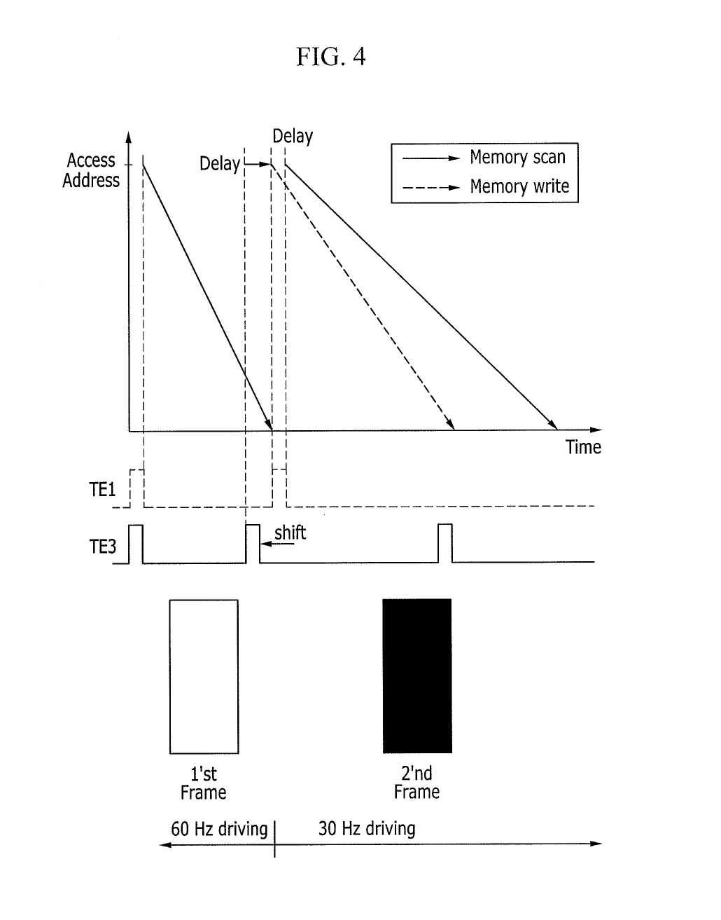

FIG. 4 illustrates a memory scan and a memory write in a case where the output time of the TE signal is advanced according to one embodiment. The TE signal which has its output time advanced is referred to as TE3.

Referring to FIG. 4, driver 120 performs the memory scan at the first frequency in the first frame. At this time, signal controller 123 transmits the TE1 signal to the controller 130. In the first frame, display unit 110 outputs first image data according to the memory scan of driver 120. Although FIG. 3 illustrates that the entire first image data is white, the first image data may have different gray scale values in other embodiments.

Thereafter, the driver 120 changes the memory scan frequency to the second frequency. In FIG. 3, the second frequency is less than the first frequency. When the driver 120 changes the memory scan frequency to the second frequency, the signal controller 123 transmits the TE3 signal, which has an output time advanced from the output time of TE1 to controller 130.

The controller 130 transmits the second image data based on the TE3 signal. In this case, the TE3 signal is transmitted to controller 130 at an earlier timing than the existing TE1 signal. The driver 120 performs a memory write operation when the second image data is received. Accordingly, the memory write operation starts earlier than the memory scan of the second frame. Further, because the memory scan frequency is reduced from the first frequency to the second frequency, the memory scan is performed from a first access address to a last access address of the internal memory 121 at a slower speed compared with the first frequency. As a result, the memory scan operation is performed only for the access address for which the memory write operation has been performed. Accordingly, in the second frame, the second image data is output to the display unit 110.

That is, driver 120 determines, in advance, a case where the memory scan for internal memory 121 and the memory write for internal memory 121 alternate and transmits the TE3 signal, having an output time which is advanced from the output time of the TE1 signal, to the controller 130.

In FIG. 4, the first frequency is 60 Hz and the second frequency is 30 Hz. The first and second frequencies may have different values in other embodiments. Also, in FIG. 4, the entire second image data is black. However, the second image data may have one or more difference gray scale values in other embodiments.

Thereafter, because controller 130 does not transmit new image data, the second image data is also output in the third, fourth, and fifth frames.

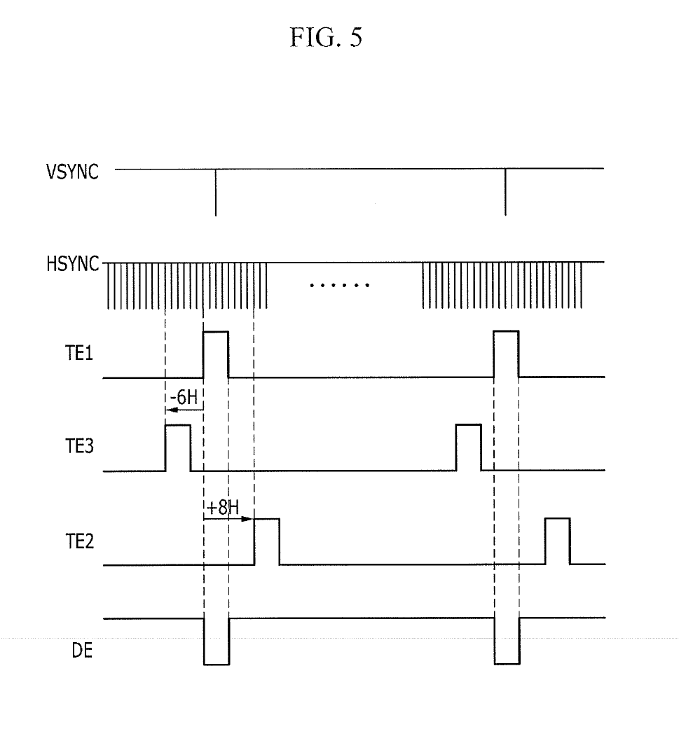

FIG. 5 illustrates an embodiment of signal waveforms for TE1, TE2, and TE3. In FIG. 5, a waveform of signal TE1 when there is no change in frequency may be opposite to a waveform of the data enable signal DE. That is, TE1 is low when data enable signal DE is high, and TE1 is high when data enable signal DE is low.

The output time of TE2 is later than the output time of TE1. For example, the output time of TE2 may be 8H later than the output time of TE1. In other embodiments, the output time of TE2 may be a different number of horizontal periods later than the output time of TE1.

The output time of TE3 is earlier than the output time of TE1. For example, the output time of TE3 may be 6H earlier than the output time of TE1 In other embodiments, the output time of TE2 may be a different number of horizontal periods earlier than the output time of TE1. Also, in FIG. 5, the waveforms of TE2 and TE3 are not opposite to (e.g., do not overlap) the waveform of the data enable signal DE.

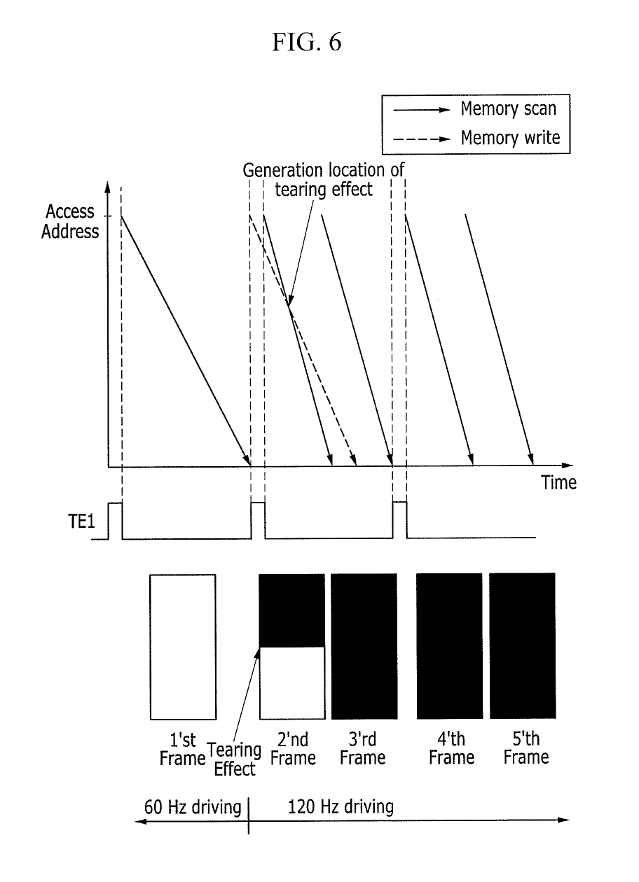

FIG. 6 illustrates a memory scan and a memory write according to a first comparative example. Referring to FIG. 6, driver 120 performs a memory scan at the first frequency in the first frame. At this time, signal controller 123 transmits the TE1 signal to controller 130. In the first frame, display unit 110 outputs first image data according to the memory scan of driver 120. Although FIG. 6 illustrates that the entire first image data is white, the first image data may have one or more different gray scale values in other embodiments.

Thereafter, driver 120 changes the memory scan frequency to the second frequency. In FIG. 6, the second frequency is greater than the first frequency. The controller 130 transmits the second image data based on the TE1 signal. The driver 120 performs a memory write operation when the second image data is received.

Thereafter, a memory scan of a second frame starts. That is, the memory write operation is performed before the memory scan operation. Because the memory scan frequency increases from the first frequency to the second frequency, the memory scan operation is performed from a first access address to a last access address of the internal memory 121 at a faster speed compared with the first frequency. As a result, even though the memory scan starts later, the memory write may end later.

Accordingly, driver 120 performs the memory scan for the access address, for which the memory write has not yet been performed. Therefore, a tearing effect (in which the first and second image data are simultaneously output to display unit 110) is generated in the second frame, in which driver 120 performs the memory scan. This tearing effect may occur even though a memory write has not been performed for the access address.

In FIG. 6, the first frequency is 60 Hz and the second frequency is 120 Hz. In other embodiments, the first and second frequencies may have different values. Further, in FIG. 6, the entire second image data is black. In other embodiments, the second image data may have one or more gray scale values different from black.

Thereafter, because controller 130 does not transmit new image data, the second image data is also output in the third, fourth, and fifth frames.

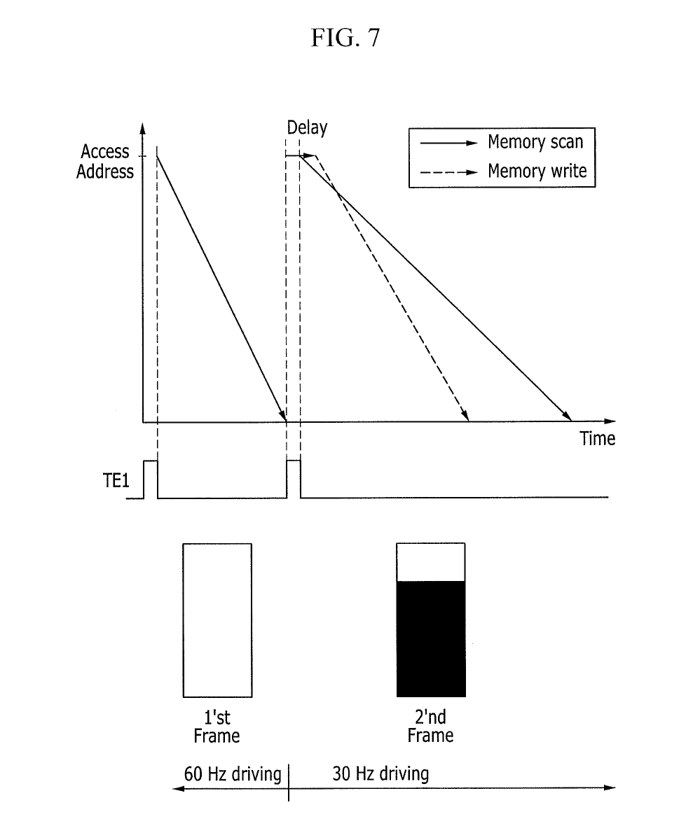

FIG. 7 illustrates a memory scan and a memory write according to a second comparative example. Referring to FIG. 7, driver 120 performs the memory scan at the first frequency in the first frame. At this time, signal controller 123 transmits the TE1 signal to controller 130. In the first frame, display unit 110 outputs first image data according to the memory scan of driver 120. In FIG. 7, the entire first image data is white. In other embodiments, the first image data may include one or more different gray scale values.

Thereafter, driver 120 changes the memory scan frequency to the second frequency. In FIG. 6, the second frequency is less than the first frequency. The controller 130 transmits the second image data based on the TE1 signal. Thereafter, the memory scan of a second frame starts.

Then, driver 120 performs the memory write when the second image data is received. At this time, because the memory scan frequency decreases from the first frequency to the second frequency, driver 120 performs the memory scan from a first access address to a last access address of the internal memory 121 at a slower speed in compared with the first frequency. As a result, even though the memory scan starts earlier, the memory write may end earlier.

Accordingly, driver 120 performs the memory write even for an access address for which the memory scan has not yet been performed. Therefore, a tearing effect (in which the first and second image data are simultaneously output to display unit 110) is generated in the second frame, in which driver 120 performs a memory write. This may occur even for an access address for which a memory scan operation has not been performed.

In FIG. 7, the first frequency is 60 Hz and the second frequency is 30 Hz. In other embodiments, the first and second frequencies may have different values. Further, in FIG. 7, the entire second image data is black. In other embodiments, the second image data may include one or more different gray scale values.

Thereafter, because controller 130 does not transmit new image data, the second image data is also output in the third, fourth, and fifth frames.

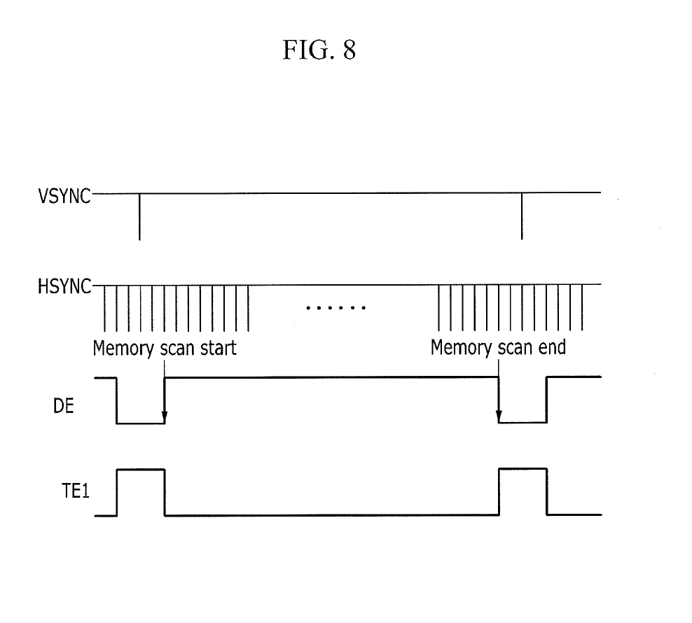

FIG. 8 illustrates an embodiment of waveforms including TE1 and DE. In FIG. 8, a waveform of signal TE1 may be opposite to (e.g., overlap) a waveform of data enable signal DE. For example, TE1 is low when data enable signal DE is high, and TE1 is high when data enable signal DE is low.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A terminal, comprising:
a controller configured to transmit image data based on a first signal;
a driver including an internal memory and configured to perform a memory write operation for the transmitted image data in the internal memory; and
a display configured to receive and output the image data for which the memory write operation in the internal memory has been performed, when a memory scan for the internal memory is performed, wherein:
the driver is configured to perform a memory scan operation at a first frequency for the internal memory, and to generate a second signal based on when the memory scan operation and memory write operation for the internal memory are to alternate, and
the controller is configured to transmit the image data based on the second signal.

2. The terminal as claimed in claim 1, wherein the driver includes:
a signal controller configured to output the first and second signals.

3. The terminal as claimed in claim 1, wherein:
when the driver performs a memory scan operation for the internal memory at a second frequency different from the first frequency, the driver is configured to output the second signal based on a size of the second frequency.

4. The terminal as claimed in claim 3, wherein:
when the second frequency is greater than the first frequency, an output time of the second signal is delayed relative to an output time of the first signal.

5. The terminal as claimed in claim 3, wherein:
when the second frequency is less than the first frequency, the output time of the second signal is advanced relative to the output time of the first signal.

6. The terminal as claimed in claim 5, wherein the first and second signals are TE signals.

7. The terminal as claimed in claim 6, wherein:
when the driver receives the image data based on the second signal, the driver is to perform the memory write operation again for the internal memory.

8. The terminal as claimed in claim 5, wherein the second frequency is 120 Hz and the first frequency is 60 Hz.

9. The terminal as claimed in claim 5, wherein the second frequency is 30 Hz and the first frequency is 60 Hz.

10. A method of controlling a terminal, the method comprising:
receiving image data transmitted based on a first signal;
performing a memory write operation for the transmitted image data in an internal memory;
performing a memory scan operation for the internal memory at a first frequency;
determining, in advance, when the memory scan operation and memory write operation for the internal memory are to alternate;
outputting a second signal based on when the memory scan operation and memory write operation are to alternate; and
receiving the transmitted image data based on the second signal.

11. The method as claimed in claim 10, further comprising:
outputting the first and second signals from a driver of a display.

12. The method as claimed in claim 10, wherein said determining includes:
performing a memory scan for the internal memory at a second frequency different from the first frequency; and
outputting the second signal based on a size of the second frequency.

13. The method as claimed in claim 12, wherein:
when the second frequency is greater than the first frequency, the second signal has an output time delayed relative to an output time of the first signal.

14. The method as claimed in claim 12, wherein:
when the second frequency is less than the first frequency, the second signal has an output time advanced relative to the output time of the first signal.

15. The method as claimed in claim 14, wherein the first and second signals are TE signals.

16. The method as claimed in claim 15, further comprising:
when the driver receives image data based on the second signal, performing the memory write operation for the internal memory again.

17. The method as claimed in claim 14, wherein the second frequency is 120 Hz and the first frequency is 60 Hz.

18. The method as claimed in claim 14, wherein the second frequency is 30 Hz and the first frequency is 60 Hz.

19. An apparatus, comprising:
an interface; and
a controller to control writing of image data to a memory and to control scanning of the memory, wherein the controller is to shift a timing of a control signal to change a frequency of a memory scan operation, the changed frequency to cause the memory scan operation to be performed for addresses of the memory for which a memory write operation has been performed, and wherein the controller is to output the control signal through the interface.

20. The apparatus as claimed in claim 19, wherein the controller is to shift the timing of the control signal based on when the memory scan operation and memory write operation are to alternate.
